(19) United States
(12) Patent Application Publication
(10) Pub. No.: US 2019/0339397 A1
(43) Pub. Date: Nov. 7, 2019

(54) Method for Operating a GNSS Receiver

(71) Applicant: Robert Bosch GmbH, Stuttgart (DE)

(72) Inventors: Achim Brenk, Kaempfelbach (DE); Joachim Schurr, Eschenbach (DE); Kai Wipplinger, Esslingen (DE); Michael Heigl, Korntal-Muenchingen (DE)

(21) Appl. No.: 16/401,940

(22) Filed: May 2, 2019

(30) Foreign Application Priority Data
May 3, 2018 (DE) 10 2018 206 789.9

(51) Int. Cl. G01S 19/34

(52) U.S. Cl. CPC G01S 19/34

(57) ABSTRACT

A method for operating a GNSS receiver includes starting a search for GNSS satellites. The search is terminated in response to a first termination condition being met after a first searching time. The search is terminated in response to a second termination condition, different from the first termination condition, being met after a second searching time that is longer than the first searching time.

This application claims priority under 35 U.S.C. § 119 to patent application no. DE 10 2018 206 789.9, filed on May 3, 2018 in Germany, the disclosure of which is incorporated herein by reference in its entirety.

The disclosure relates to a method for operating a GNSS receiver, to a computer program, to a machine-readable storage medium and to a GNSS receiver.

### BACKGROUND

GNSS receivers are used for the satellite-based determination of a geographical position. These GNSS receivers normally perform propagation time measurements of GNSS satellite signals from at least four satellites in order to establish a GNSS position therefrom. Prior to determining a GNSS-based position, the GNSS receivers normally search for the signals from the satellites for a specific set time, before the position determination is terminated without success possibly due to lack of satellites being found. This set time is independent of how many satellites were detected at which time. If a position is not able to be established after this predefined duration has expired, the position establishment procedure is terminated without success.

### SUMMARY

What is proposed here according to the disclosure is a method for operating a GNSS receiver, comprising the following steps:
a) starting a search for GNSS satellites,
b) terminating the search if a first termination condition is met after a first searching time,
c) terminating the search if a second termination condition, different from the first termination condition, is met after a second searching time, wherein the second searching time is longer than the first searching time.

The method in particular contributes to saving energy when determining a GNSS position. Using the solution proposed here, a multi-stage method involving termination conditions, in particular depending on times, number and/or signal status of the detected satellites, is advantageously able to be used to shorten the time to search for satellites depending on the conditions cited above. Energy is thus particularly advantageously able to be saved, especially in a manner relevant to battery-operated devices. The solution proposed here is distinguished in particular in that the search for satellites takes place in stages, with individual termination conditions after each stage.

One particularly advantageous aspect of the solution presented here is the dynamic adjustment of the time in the search for satellites in position determination devices, in particular depending on conditions such as time, number and/or signal status (for example SNR) of detected satellites. One particular advantage of the solution presented here may be seen in the termination of the search for satellites depending on the likelihood of a successful position determination, the associated shortening of the searching times and the resultant energy saving due to unnecessary satellite searches, for example if a device is situated in a building or the reception from the satellites is blocked in another way.

According to the solution proposed here, the search is performed in particular in steps. The search may in this case advantageously be terminated after each step, provided that the condition required for this step is not met. As such a condition, there may in particular be provision that at least a particular number of satellites having a particular minimum signal quality has to be found after a particular step. By way of the solution proposed here, a fruitless search (for example from a building) may advantageously be terminated without success earlier than in known searching methods, such that energy is able to be saved, especially in battery-operated GNSS receivers.

A search for GNSS satellites starts in step a). To this end, for example, a GNSS antenna may be activated via which signals may be received from navigation satellites and forwarded to the GNSS receiver as raw data or in preprocessed form. As an alternative or in addition, a GNSS input of the GNSS receiver may be activated in order to start the search.

GNSS stands for global navigation satellite system. GNSS is a system for establishing position and/or navigation on the ground and/or in the air by receiving signals from navigation satellites, referred to here as satellite data. GNSS is in this case a collective term for the use of existing and future global satellite systems, such as GPS (NAVSTRAR GPS), GLONASS, Beidou and Galileo. A GNSS sensor is therefore a sensor system suitable for receiving navigation satellite data and processing or evaluating them. The GNSS sensor is preferably capable of determining a highly accurate vehicle position with the aid of navigation satellite data (GPS, GLONASS, Beidou, Galileo). GNSS data are in particular data that are received from a navigation satellite, and GNSS data may also be referred to as “navigation satellite data”.

The search is terminated in step b) if a first termination condition is met after an in particular predefined first searching time. The GNSS receiver preferably provides feedback, following the termination in step b), that the position determination was unsuccessful. The GNSS receiver is furthermore preferably put into an energy-saving mode or standby mode after the termination in step b).

The search is terminated in step c) if a second termination condition, different from the first termination condition, is met after an in particular predefined second searching time, wherein the second searching time is longer than the first searching time. The first searching time and the second searching time generally begin at the same time, in particular with the start of the search according to step a). The GNSS receiver preferably provides feedback, following the termination in step c), that the position determination was unsuccessful. The GNSS receiver is furthermore preferably put into an energy-saving mode or standby mode after the termination in step c).

According to one advantageous refinement, it is proposed for the search to start when a starting condition is met. The signal from an acceleration sensor or from a vehicle in or on which the GNSS receiver is arranged may serve as starting condition, for example. An ignition signal that indicates that a vehicle in or on which the GNSS receiver is arranged has been started may furthermore serve as starting condition.

According to one advantageous refinement, it is proposed for the first termination condition to comprise at least a first satellite number or a first signal status. The first termination condition preferably comprises a predefined first satellite number and/or a predefined first signal status. The first termination condition preferably contains the condition whereby the search is terminated if at least an in particular predefined first satellite minimum number or an in particular predefined first satellite minimum signal status has not been reached or is not available. The first termination condition particularly preferably contains the condition whereby the search is terminated if a first minimum number of satellites that in particular (each) provide a first satellite minimum signal status has not been found. By way of example, the first termination condition may contain the condition whereby the search is terminated if at least one satellite (with a sufficient signal status) has not been found. A satellite minimum signal status may for example comprise a minimum signal quality and/or minimum signal strength of a satellite signal.

According to one advantageous refinement, it is proposed for the second termination condition to comprise at least a second satellite number or a second signal status. The second termination condition preferably comprises a predefined second satellite number and/or a predefined second signal status. The second termination condition preferably contains the condition whereby the search is terminated if at least an in particular predefined second satellite minimum number or an in particular predefined second satellite minimum signal status has not been reached or is not available. The second termination condition particularly preferably contains the condition whereby the search is terminated if a second minimum number of satellites that in particular (each) provide a second satellite minimum signal status has not been found. By way of example, the second termination condition may contain the condition whereby the search is terminated if at least two satellites (with a sufficient signal status) have not been found.

According to one advantageous refinement, it is proposed for the search to be terminated in a step d) if a third termination condition is met after an in particular predefined third searching time, wherein the third searching time is longer than the second searching time. The third termination condition in particular differs from the first and the second termination condition. The first searching time, the second searching time and the third searching time generally begin at the same time, in particular with the start of the search according to step a). The GNSS receiver preferably provides feedback, following the termination in step d), that the position determination was unsuccessful. The GNSS receiver is furthermore preferably put into an energy-saving mode or standby mode after the termination in step d).

According to a further advantageous refinement, it is proposed for the third termination condition to comprise at least a third satellite number or a third signal status. The third termination condition preferably comprises a predefined third satellite number and/or a predefined third signal status. The third termination condition preferably contains the condition whereby the search is terminated if at least an in particular predefined third satellite minimum number or an in particular predefined third satellite minimum signal status has not been reached or is not available. The third termination condition particularly preferably contains the condition whereby the search is terminated if a third minimum number of satellites that in particular (each) provide a third satellite minimum signal status has not been found. By way of example, the third termination condition may contain the condition whereby the search is terminated if at least three satellites (with a sufficient signal status) have not been found.

According to one advantageous refinement, it is proposed, if none of the termination conditions are met after expiry of the (all of the provided) searching times, for an in particular geographical GNSS position to be determined and provided and the GNSS receiver then to be put (back) into an energy-saving mode. As an alternative or in addition to the energy-saving mode, the GNSS receiver may be put into a standby mode. However, it is furthermore possible, if none of the termination conditions are met after expiry of the (all of the provided) searching times, for an in particular geographical GNSS position to be determined and provided (without the GNSS receiver then being put into an energy-saving mode).

The GNSS position may be determined for example by the GNSS receiver itself or in a GNSS sensor that is connected to the GNSS receiver.

According to one advantageous refinement, it is proposed, if only the last of the termination conditions is met after expiry of the (all of the provided) searching times, for it to be checked whether a limited position determination is possible. A limited position determination may mean for example that only a two-dimensional (length, width) GNSS position (with assumed height) is established. The check is particularly advantageously made dependent on whether an in particular predefined minimum number of satellites has been found. By way of example, a two-dimensional GNSS position with known or assumed height may generally be determined or estimated with just three satellites.

If a limited position determination is possible, this may be determined and preferably provided with an indication of quality as to the determined position. The GNSS receiver may then be put (back) into an energy-saving mode. If a limited position determination is not possible, unsuccessful position determination is generally fed back and the GNSS receiver is then put (back) into an energy-saving mode.

According to a further aspect, a computer program for performing a method presented here is proposed. In other words, this relates in particular to a computer program (product) comprising commands that prompt a computer, when the program is executed by said computer, to execute a method described here.

According to a further aspect, a machine-readable storage medium is proposed on which the computer program proposed here is stored. The machine-readable storage medium is normally a computer-readable data carrier.

According to a further aspect, a GNSS receiver is proposed that is configured so as to perform a method proposed here. By way of example, the storage medium described above may be part of the GNSS receiver or be connected thereto. The GNSS receiver is preferably arranged in or on a vehicle or provided and configured for installation in or on such a vehicle. The GNSS receiver or a computer unit (processor) of the GNSS receiver may for example access the computer program described here in order to execute a method described here.

The GNSS receiver is preferably a GNSS sensor. The calculation of the position is based on the propagation time measurement of the (electromagnetic) GNSS signals from at least four satellites. Furthermore, correction data from what are known as correction services may be jointly used in the sensor in order to calculate the position even more accurately. Together with the received GNSS data, a highly accurate time (such as Universal Time) is also regularly read in the sensor and used for accurate position establishment. Further input data into the position sensor may be (inter alia) wheel speeds, steering angles, and acceleration and rate of rotation data. The movement and position sensor is preferably configured so as to determine its own position, its own orientation and/or its own speed on the basis of GNSS data.

The details, features and advantageous refinements explained in connection with the method may also apply accordingly to the GNSS receiver presented here, to the computer program and/or to the storage medium, and vice versa. In this respect, full reference is made to the explanations there in order to better characterize the features.

### BRIEF DESCRIPTION OF THE DRAWINGS

The solution presented here and its technical field are explained in more detail below with reference to the figures. It should be pointed out that the disclosure is not intended to be limited by the exemplary embodiments that are shown. In particular, unless explicitly indicated otherwise, it is also possible to extract partial aspects of the scenarios explained in the figures and to combine them with other components and/or knowledge from other figures and/or the present description. In the drawings:

FIG. 1: schematically shows a sequence of a method presented here for operating a GNSS receiver in a regular mode of operation, and

FIG. 2: schematically shows a flowchart of an exemplary sequence of a method presented here.

### DETAILED DESCRIPTION

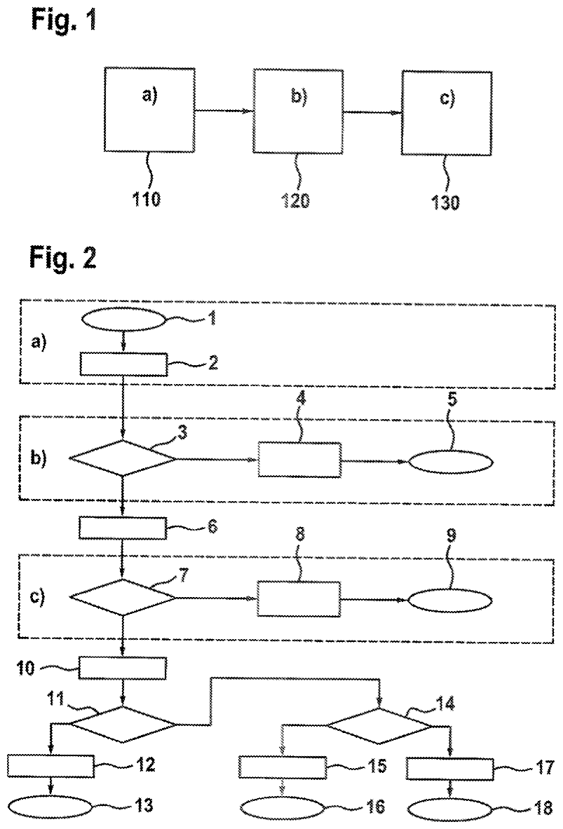

FIG. 1 schematically shows a sequence of a method presented here for operating a GNSS receiver in a regular mode of operation.

The series shown here of the method steps a), b) and c) with the blocks 110, 120 and 130 is merely exemplary.

A search for GNSS satellites starts in block 110. The search is terminated in block 120 if a first termination condition is met after a first searching time. The search is terminated in block 130 if a second termination condition, different from the first termination condition, is met after a second searching time, wherein the second searching time is longer than the first searching time.

FIG. 2 schematically shows a flowchart of an exemplary sequence of a method presented here.

The flowchart begins with a first terminator 1, which here contains the condition whereby an acceleration has been detected, by way of example. The first terminator 1 is followed by a first operation 2 that contains the condition whereby a timer and the search for satellites are started (step a)). In other words, after detection of a trigger condition, for example an acceleration, a timer and the search for satellites for position determination are started.

The first operation 2 is followed by a first decision 3. The first decision 3 is made at a (pre)defined time t₁ or after expiry of the first searching time.

The first decision 2 contains the query as to whether the number of satellites found is higher than a (pre)defined first satellite number n₁ and/or whether the satellite signal status is higher than a (pre)defined first satellite signal status Q₁.

If the first decision 3 delivers a negative result, then this is followed by a second operation 4, which here contains the condition whereby feedback is provided that the position determination was unsuccessful. This corresponds to step b). The second operation 4 is followed here by way of example by a second terminator 5, which here contains the condition whereby the GNSS receiver is put into an energy-saving mode or standby mode, by way of example.

If at least n₁ satellites with a sufficient signal status Q₁ are not detected at the time t₁, the probability of finding a sufficient number of satellites with sufficient signal status for successful position determination is too low, and so the search is terminated and the device is put back into an energy-saving mode.

If the first decision 3 delivers a positive result, then this is followed by a third operation 6 that contains the condition whereby the search for satellites is continued.

If a sufficient number of satellites n₁ with a sufficient signal status Q₁ is detected at the time t₁, the search is continued until the time t₂, at which there is a further query as to the number of satellites n₂ and the respective signal status Q₂, and the process is performed here analogously to time t₁.

The third operation 6 is accordingly followed by a second decision 7. The second decision 7 is made at a (pre)defined time t₂ or after expiry of the second searching time. The second decision 7 contains the query as to whether the number of satellites found is higher than a (pre)defined second satellite number n₂ and/or whether the satellite signal status is higher than a (pre)defined second satellite signal status Q₂.

If the second decision 7 delivers a negative result, then this is followed by a fourth operation 8, which here contains the condition whereby feedback is provided that the position determination was unsuccessful. This corresponds to step c). The fourth operation 8 is followed here by way of example by a third terminator 9, which here contains the condition whereby the GNSS receiver is put into an energy-saving mode or standby mode, by way of example.

If the second decision 7 delivers a positive result, then this is followed by a fifth operation 10 that contains the condition whereby the search for satellites is continued.

If a sufficient number of satellites n₂ with sufficient signal status Q₂ is detected at the time t₂, the search is continued until the time t₃, at which there is a further query as to the number of satellites n₃ and the respective signal status Q₃.

The fifth operation 10 is thus followed by a third decision 11. The third decision 11 is made at a (pre)defined time t₃ or after expiry of the third searching time. The third decision 11 contains the query as to whether the number of satellites found is higher than a (pre)defined third satellite number n₃ and/or whether the satellite signal status is higher than a (pre)defined third satellite signal status Q₃.

If the third decision 11 delivers a positive result, then this is followed by a sixth operation 12, which contains the condition whereby a three-dimensional or spatial GNSS position is determined and provided. The sixth operation 12 is followed by a fourth terminator 13, which here contains the condition whereby the GNSS receiver is put into an energy-saving mode or standby mode, by way of example.

If a sufficient number of satellites for a 3D position determination is detected at the time t₃, the position is determined and for example transmitted, and the device is then put back into an energy-saving mode.

If the third decision 11 delivers a negative result, then this is followed here by a fourth decision 14. The fourth decision 14 contains the query as to whether a limited position determination is possible.

If the fourth decision 14 delivers a positive result, then this is followed by a seventh operation 15, which here contains the condition whereby a two-dimensional GNSS position is determined and provided with an indication of quality, by way of example. The seventh operation 15 is followed by a fifth terminator 16, which here contains the condition whereby the GNSS receiver is put into an energy-saving mode or standby mode, by way of example.

If the fourth decision 14 delivers a negative result, then this is followed by an eighth operation 17, which here contains the condition whereby feedback is provided that the position determination was unsuccessful, by way of example. The eighth operation 17 is followed by a sixth terminator 18, which here contains the condition whereby the GNSS receiver is put into an energy-saving mode or standby mode, by way of example.

If a sufficient number of satellites for a 3D position determination is not detected at the time t₃, it is checked whether a 2D position with limited accuracy is able to be determined, and if so, this is transmitted with an indication of quality as to the determined position and the device is then put back into an energy-saving mode. If not, unsuccessful position determination is fed back and the device is then put back into an energy-saving mode.

If the GNSS receiver has been put into an energy-saving mode or standby mode, the method may in particular start again from the beginning (at terminator 1) if an acceleration has been detected again.

The times tₓ, the number of satellites nₓ and the requirements in terms of the respective signal status Qₓ may be adjusted as required. The method may likewise be implemented with more than three stages.

The solution presented here in particular makes possible one or more of the following advantages:
A fruitless or probably fruitless search for GNSS satellites is able to be significantly shortened using the solution proposed here.
Energy is able to be saved, especially in a manner relevant to battery-operated devices, using the solution proposed here.

What is claimed is:

1. A method for operating a GNSS receiver, comprising:
starting a search for GNSS satellite;
terminating the search in response to a first termination condition being met after a first searching time; and
terminating the search in response to a second termination condition being met after a second searching time, wherein:
the second termination condition is different from the first termination condition; and
the second searching time is longer than the first searching time.

2. The method of claim 1, wherein the search is started in response to a starting condition being met.

3. The method of claim 1, wherein the first termination condition includes a first satellite number or a first signal status.

4. The method of claim 1, wherein the second termination condition includes a second satellite number or a second signal status.

5. The method of claim 1, further comprising:
terminating the search in response to a third termination condition being met after a third searching time, wherein the third searching time is longer than the second searching time.

6. The method of claim 5, wherein the third termination condition includes a third satellite number or a third signal status.

7. The method of claim 1, further comprising:
in response to none of terminating conditions being met after expiry of the searching times, determining and providing a GNSS position, and causing the GNSS receiver to enter an energy-saving mode.

8. The method of claim 1, further comprising:
in response to only a last terminating condition being met after expiry of the searching times, determine whether a limited position determination is possible.

9. The method of claim 1, wherein the method is performed by executing a computer program.

10. The method of claim 9, wherein the computer program is stored on a machine-readable storage medium.

11. A GNSS receiver configured to:
start a search for GNSS satellite;
terminate the search in response to a first termination condition being met after a first searching time; and
terminate the search in response to a second termination condition being met after a second searching time, wherein:
the second termination condition is different from the first termination condition; and
the second searching time is longer than the first searching time.
